(19) United States
(12) Patent Application Publication
(10) Pub. No.: US 2024/0430709 A1
(43) Pub. Date: Dec. 26, 2024

(54) INTELLIGENT WIRELESS NETWORK DESIGN SYSTEM

(71) Applicant: ITRA Wireless Ai, LLC, New York, NY (US)

(72) Inventors: Andriy Khomenko, New York, NY (US); Maxim Kormilitsin, Dallas, TX (US)

(21) Appl. No.: 18/827,052

(22) Filed: Sep. 6, 2024

Related U.S. Application Data
(63) Continuation-in-part of application No. 17/566,612, filed on Dec. 30, 2021, now Pat. No. 12,114,175.

(51) Int. Cl. H04W 24/02; G06V 10/764; G06V 20/17; G06V 20/52; G06V 20/64; G06V 20/70; H04B 17/391

(52) U.S. Cl. CPC H04W 24/02; G06V 10/764; G06V 20/17; G06V 20/52; G06V 20/64; G06V 20/70; H04B 17/3913

(57) ABSTRACT

A system for automated ML-based design of a wireless network. The system includes a processor and a memory on which are stored machine-readable instructions that when executed by the processor, cause the processor to: acquire aerial surveillance data of a target area, the aerial surveillance data comprising a point cloud dataset; initiate parsing of the point cloud dataset in intervals defined by a plurality of 3-D units of a predetermined volume; and replace the plurality of point cloud data points within the particular 3-D unit with a single data point indicative of a common surface classification type. The system can generate a discretized 3-D mapping of point cloud dataset.

### CROSS REFERENCE TO RELATED APPLICATIONS

This application is a continuation-in-part patent application of, and claims the benefit of and priority to, U.S. Non-Provisional patent application Ser. No. 17/566,612, filed on Dec. 30, 2021, and entitled “Intelligent Wireless Network Design System,” the disclosure of which is incorporated by reference in its entirety as if the same were fully set forth herein.

### FIELD OF DISCLOSURE

The present disclosure generally relates to designing wireless networks, and more particularly, to an intelligent machine learning (ML)-based automated system for wireless network design and optimization.

### BACKGROUND

Wireless network systems are conventionally implemented based on design specification, area, equipment requirements, budgets, etc.

The process of network implementation and tower site selection is a concern of property owners worldwide. Securing tower locations is the result of network designers working with their internal engineering staff to satisfy specific needs of that company in certain locations throughout the area. The engineering aspect is referred to as “Radio Frequency Engineering” or RF Engineering, for short. The RF engineers must act in concert with the site development and construction staff to optimize any cell tower site development and related construction projects that may have been scheduled.

A goal of a conventional wireless network design is to provide:
Signal Quality/Strength/Coverage: Cell towers are built to eliminate those locations where the services may be lacking, known as the “Dead Spot.” Typically, the RF Engineers determine where there are high rates of service interruption due to either interference or signal issues, then, a new cell tower site is selected and_developed to eliminate these dead areas.
Data Usage Capacity: With the high demand for wireless connectivity to multiple devices and the data usage required for these devices, there must be an adequate amount of cell towers to facilitate such demand. The main reasons new tower locations are being selected and constructed are to meet these growing data usage needs and technological advancements.
Call Clarity and Network Speed: The telecom industry is a complex industry but like most, it relies on increasing its customer base and satisfying the needs of its existing customers. Therefore, network must be designed and constructed to make sure customer needs are met.

Additionally, the network design must meet needs and restrictions as it relates to the ground space requirements for the selection, development and construction of new towers. The primary focus of companies is leasing ground space in both urban and rural areas for locations that have at least 1,500 square feet of ground space.

While the companies are always surveying the areas to make sure they are meeting the needs warranting faster, broader networks and the towers that can facilitate service for these networks, the network design process remains manual or semi-manual relying on static data and intuition of the RF engineers. This prevents the implementation of the most optimal network design. Furthermore, this approach also remains predominantly two-dimensional, with the intended area of coverage mostly being the surface area just above ground or floor of a building. The current networks may include a plethora of IoT devices on the ground, just above the surface, and in the air. The conventual manual approach is increasingly difficult to apply and scale for these networks.

Accordingly, a system and method for intelligent machine learning (ML)-based automated network design and optimization are desired.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

One embodiment of the present disclosure provides a system for an automated ML-based design of a wireless network. The system includes a processor of a design server node run locally, on the edge, or connected to at least one cloud server node over a network and a memory on which are stored machine-readable instructions that when executed by the processor, cause the processor to: acquire aerial surveillance data of a target area from an unmanned aircraft system (UAS) flying over the target area; parse the aerial surveillance data to derive an at least one feature vector; provide the at least one feature vector to a machine learning (ML) module residing on the at least one cloud server node for generating a predictive model of a wireless network for the target area; receive outputs of the predictive model; and generate a wireless network design for the target area based on the predictive outputs. The system includes a processor of a design server node run locally, on the edge, or connected to at least one cloud server node over a network and a memory on which are stored machine-readable instructions that when executed by the processor, cause the processor to: acquire 3-D mapping data of some or all of the target area from a sensor system mounted on an unmanned aircraft system (UAS) flying over and/or a robotic ground crawler moving on the surface of the target area; parse the 3-D mapping data to prepare it for being a direct or an indirect input into a signal quality ML model; run at least one or a plethora instances of a signal quality ML model or models running locally, on the edge, or residing on the at least one cloud server node, based on at least one combination of target area points and network configuration parameters; receive outputs of the predictive model; compare the outputs of the signal quality ML model(s) and select those that meet selection criteria; present the selected network designs to a user for a final decision.

Another embodiment of the present disclosure provides a method that includes one or more of: acquiring aerial surveillance 3-D mapping data of a target area from an unmanned aircraft system (UAS) flying over some or all of the target area; acquiring 3-D mapping data from a ground robotic system crawling over some or all of the target area; parsing the aerial surveillance 3-D mapping data and the ground survey 3-D mapping data to derive an at least one feature vector; providing the at least one feature vector to a machine learning (ML) module residing on the at least one cloud server node for generating a predictive model of a wireless network for the target area; receiving a plurality of outputs of the predictive model; and generating a wireless network design for the target area based on the plurality of the predictive outputs.

Another embodiment of the present disclosure provides a computer-readable medium including instructions for acquiring aerial surveillance 3-D mapping data of a target area from an unmanned aircraft system (UAS) flying over some or all of the target area or for acquiring 3-D mapping data from a ground robot crawling over some or all of the target area; parsing the 3-D mapping data to derive an at least one feature vector; providing the at least one feature vector to a machine learning (ML) module running locally, on the edge, or residing on the at least one cloud server node for generating a predictive model of a wireless network for the target area; receiving a plurality of outputs of the predictive model; and generating a wireless network design for the target area based on the plurality of the predictive outputs.

According to a first aspect, the present disclosure includes a system including: a processor; and a memory on which are stored machine-readable instructions that when executed by the processor, cause the processor to: acquire aerial surveillance data of a target area, wherein the aerial surveillance data includes a point cloud dataset; initiate parsing of the point cloud dataset in intervals defined by a plurality of three-dimensional (3-D) units of a predetermined volume, wherein parsing includes analyzing a plurality of point cloud data points located within each 3-D unit of the plurality of 3-D units of the predetermined volume; and in response to determining that a threshold amount of point cloud data points of a plurality of point cloud data points located within a particular 3-D unit are of a common surface classification type, replace the plurality of point cloud data points within the particular 3-D unit with a single data point indicative of the common surface classification type.

According to a second aspect or any other aspect herein, the system disclosed herein, wherein in response to executing the machine-readable instructions the processor is further caused to: in response to determining that a threshold amount of point cloud data points of a plurality of point cloud data points located within a subsequent 3-D unit are not of a common surface classification type, replace the subsequent 3-D unit with a subdivided 3-D unit including a plurality of tessellated 3-D units; initiate parsing of the point cloud dataset in intervals defined by the plurality of tessellated 3-D units; and in response to determining that a threshold amount of point cloud data points of a plurality of point cloud data points located within a particular tessellated 3-D unit of the plurality of tessellated 3-D units is of a common surface classification type, replace the point cloud data points within the particular tessellated 3-D unit with a single data point indicative of the common surface classification type.

According to a third aspect or any other aspect herein, the system disclosed herein, wherein each tessellated 3-D unit includes a volume that is less than the predetermined volume.

According to a fourth aspect or any other aspect herein, the system disclosed herein, wherein in response to executing the machine-readable instructions the processor is further caused to: in response to replacing the plurality of point cloud data points located within each 3-D unit of the plurality of 3-D units with a single data point indicative of the common surface classification type, generate a discretized 3-D mapping of the point cloud dataset including each of the single data points indictive of their respective common surface classification type.

According to a fifth aspect or any other aspect herein, the system disclosed herein, wherein in response to executing the machine-readable instructions the processor is further caused to: acquire wireless signal quality data corresponding to wireless signals detected within the target area in connection with the aerial surveillance data; and provide the wireless signal quality data and the discretized 3-D mapping to a machine learning (ML) module, wherein the ML module is operatively configured to codify base relationships characterizing known profiles and behaviors of the wireless signals and other electronic elements to be used in a wireless network design for the target area.

According to a sixth aspect or any other aspect herein, the system disclosed herein, wherein the aerial surveillance data includes photogrammetry data, LiDAR data, and/or thermal imagery data.

According to a seventh aspect or any other aspect herein, the system disclosed herein, wherein the wireless signal quality data includes 3-D sequential signal quality data collected by a signal detection device passing through a plurality of vertical planes located at a standard distance from each other over the target area.

According to an eighth aspect, the present disclosure describes a method including: acquiring aerial surveillance data of a target area, wherein the aerial surveillance data includes a point cloud dataset; initiating parsing of the point cloud dataset in intervals defined by a plurality of three-dimensional (3-D) units of a predetermined volume, wherein parsing includes analyzing a plurality of point cloud data points located within each 3-D unit of the plurality of 3-D units of the predetermined volume; and in response to determining that a threshold amount of point cloud data points of a plurality of point cloud data points located within a particular 3-D unit are of a common surface classification type, replacing the plurality of point cloud data points within the particular 3-D unit with a single data point indicative of the common surface classification type.

According to a ninth aspect or any other aspect herein, the method disclosed herein, further including: in response to determining that a threshold amount of point cloud data points of a plurality of point cloud data points located within a subsequent 3-D unit are not of a common surface classification type, replacing the subsequent 3-D unit with a subdivided 3-D unit including a plurality of tessellated 3-D units; initiating parsing of the point cloud dataset in intervals defined by the plurality of tessellated 3-D units; and in response to determining that a threshold amount of point cloud data points of a plurality of point cloud data points located within a particular tessellated 3-D unit of the plurality of tessellated 3-D units is of a common surface classification type, replacing the point cloud data points within the particular tessellated 3-D unit with a single data point indicative of the common surface classification type.

According to a tenth aspect or any other aspect herein, the method disclosed herein, wherein each tessellated 3-D unit includes a volume that is less than the predetermined volume.

According to an eleventh aspect or any other aspect herein, the method disclosed herein, further including: in response to replacing the plurality of point cloud data points located within each 3-D unit of the plurality of 3-D units with a single data point indicative of the common surface classification type, generating a discretized 3-D mapping of the point cloud dataset including each of the single data points indictive of their respective common surface classification type.

According to a twelfth aspect or any other aspect herein, the method disclosed herein, further including: acquiring wireless signal quality data corresponding to wireless signals detected within the target area in connection with the aerial surveillance data; and providing the wireless signal quality data and the discretized 3-D mapping to a machine learning (ML) module, wherein the ML module is operatively configured to codify base relationships characterizing known profiles and behaviors of the wireless signals and other electronic elements to be used in a wireless network design for the target area.

According to a thirteenth aspect or any other aspect herein, the method disclosed herein, wherein the aerial surveillance data includes photogrammetry data, LiDAR data, and/or thermal imagery data.

According to a fourteenth aspect or any other aspect herein, the method disclosed herein, wherein the wireless signal quality data includes 3-D sequential signal quality data collected by the UAS passing through a plurality of vertical planes located at a standard distance from each other over the target area.

According to a fifteenth aspect, a non-transitory computer readable medium including instructions is described herein that, when read by a processor, cause the processor to perform: acquiring aerial surveillance data of a target area, wherein the aerial surveillance data includes a point cloud dataset; initiating parsing of the point cloud dataset in intervals defined by a plurality of three-dimensional (3-D) units of a predetermined volume, wherein parsing includes analyzing a plurality of point cloud data points located within each 3-D unit of the plurality of 3-D units of the predetermined volume; and in response to determining that a threshold amount of point cloud data points of a plurality of point cloud data points located within a particular 3-D unit are of a common surface classification type, replacing the plurality of point cloud data points within the particular 3-D unit with a single data point indicative of the common surface classification type.

According to a sixteenth aspect or any other aspect herein, the non-transitory computer readable medium including instructions described herein, further including instructions that when read by the processor, cause the processor to perform: in response to determining that a threshold amount of point cloud data points of a plurality of point cloud data points located within a subsequent 3-D unit are not of a common surface classification type, replacing the subsequent 3-D unit with a subdivided 3-D unit including a plurality of tessellated 3-D units; initiating parsing of the point cloud dataset in intervals defined by the plurality of tessellated 3-D units; and in response to determining that a threshold amount of point cloud data points of a plurality of point cloud data points located within a particular tessellated 3-D unit of the plurality of tessellated 3-D units is of a common surface classification type, replacing the point cloud data points within the particular tessellated 3-D unit with a single data point indicative of the common surface classification type.

According to a seventeenth aspect or any other aspect herein, the non-transitory computer readable medium including instructions described herein, wherein each tessellated 3-D unit includes a volume that is less than the predetermined volume.

According to an eighteenth aspect or any other aspect herein, the non-transitory computer readable medium including instructions described herein, further including instructions that when read by the processor, cause the processor to perform: in response to replacing the plurality of point cloud data points located within each 3-D unit of the plurality of 3-D units with a single data point indicative of the common surface classification type, generating a discretized 3-D mapping of the point cloud dataset including each of the single data points indictive of their respective common surface classification type.

According to a nineteenth aspect or any other aspect herein, the non-transitory computer readable medium including instructions described herein, further including instructions that when read by the processor, cause the processor to perform: acquiring wireless signal quality data corresponding to wireless signals detected within the target area in connection with the aerial surveillance data; and providing the wireless signal quality data and the discretized 3-D mapping to a machine learning (ML) module, wherein the ML module is operatively configured to codify base relationships characterizing known profiles and behaviors of the wireless signals and other electronic elements to be used in a wireless network design for the target area.

According to a twentieth aspect or any other aspect herein, the non-transitory computer readable medium including instructions described herein, wherein the aerial surveillance data includes photogrammetry data, LiDAR data, and/or thermal imagery data, and wherein the wireless signal quality data includes 3-D sequential signal quality data collected by a signal detection device passing through a plurality of vertical flight planes located at a standard distance from each other over the target area.

Both the foregoing brief overview and the following detailed description provide examples and are explanatory only. Accordingly, the foregoing brief overview and the following detailed description should not be considered to be restrictive. These and other aspects, features, and benefits of the claimed embodiment(s) will become apparent from the following detailed written description of the preferred embodiments and aspects taken in conjunction with the following drawings, although variations and modifications thereto may be effected without departing from the spirit and scope of the novel concepts of the disclosure.

Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1A illustrates a network diagram of a system for ML-based network design process employing 3-D mapping data consistent with the present disclosure;

FIG. 1B illustrates a network diagram of a system for ML-based network design process employing signal quality data consistent with the present disclosure;

FIG. 1C illustrates a network diagram of a system for ML-based network design process employing surveillance data and a blockchain network consistent with the present disclosure;

FIG. 2 illustrates a network diagram of a system including detailed features of a design server node consistent with the present disclosure;

FIG. 3A illustrates a flowchart of a method for ML-based network design and optimization of the design processing consistent with the present disclosure;

FIG. 3B illustrates a further flow chart of a method for ML-based network design and optimization of the design processing consistent with the present disclosure;

FIG. 4 illustrates a block diagram of a system including a computing device for performing the method of FIGS. 3A and 3B.

FIG. 5 is a flowchart of an example method for point cloud data discretization, according to one aspect of the present disclosure;

FIG. 6 is a diagram of an example environment illustrating tower-to-device signal quality analysis, according to one aspect of the present disclosure; and

FIG. 7 is a flowchart of an example method for tower-to-device signal quality analysis, according to one aspect of the present disclosure.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Regarding applicability of 35 U.S.C. § 112, 16, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of processing job applicants, embodiments of the present disclosure are not limited to use only in this context.

The present disclosure provides a system, method and computer-readable medium for an intelligent ML-based automated network design and optimization.

In one embodiment of the present disclosure, the system provides for AI/ML-generated RF design options based on 3-D signal quality pattern analysis and predictions for the 3-D area map including its surface and 3-D volume above it to a target height. An automated decision model may be configured to provide for identification of the most effective backhaul type, vendor in each type, and location of the gateway module in 3-D space (accounting for downstream area network signal strength and total area network cost of service optimization problem discussed below). In one embodiment, a signal quality may be analyzed. The signal quality data may include signal strength, latency and packet loss measured in a specific unit of 3-D space overlaid with simultaneous measurements of the density of user devices in that unit of 3-D space.

In one embodiment of the present disclosure, an unmanned aircraft system UAS (such as a drone) equipped with signal measurement devices flies over a target network area intended for a network design. The UAS produces 3-D signal quality pattern data that may be provided to a design server for analysis. In one embodiment of the present disclosure, the design server may provide for discovery and calculation of the optimal location(s) of the backhaul gateway(s) using measurements taken and solving proprietary algorithm (e.g., interpolation) to discover good 3-D location candidates (e.g., latitude/longitude/height/orientation) with respect to signal strength and other parameters. The design server may perform a simultaneous assessment of trade-offs of “anchor tower” location(s) vs overall area network design. The design server may, advantageously, provide data related to implications of a total cost of ownership as well as decisioning and recommendation of top transport type, vendor, gateway model, gateway location combinations, etc.

Network design automation in accordance to the embodiments of the present disclosure may include 3-D surveillance of a target coverage area and surfaces using surveillance data produced by the UAS flying over the target area. The 3-D surveillance data may include but is not limited to photogrammetry data, Light Detection and Ranging (LiDAR) data, thermal imagery data. The 3-D surveillance data may include overlaying of third-party satellite data (if available). Analysis of the 3-D surveillance data may include a derivation of the 3-D point cloud with specificity about interference ground object types (e.g., vegetation, buildings, terrain, water volumes, surface object types—i.e., brick buildings vs glass or steel, etc.).

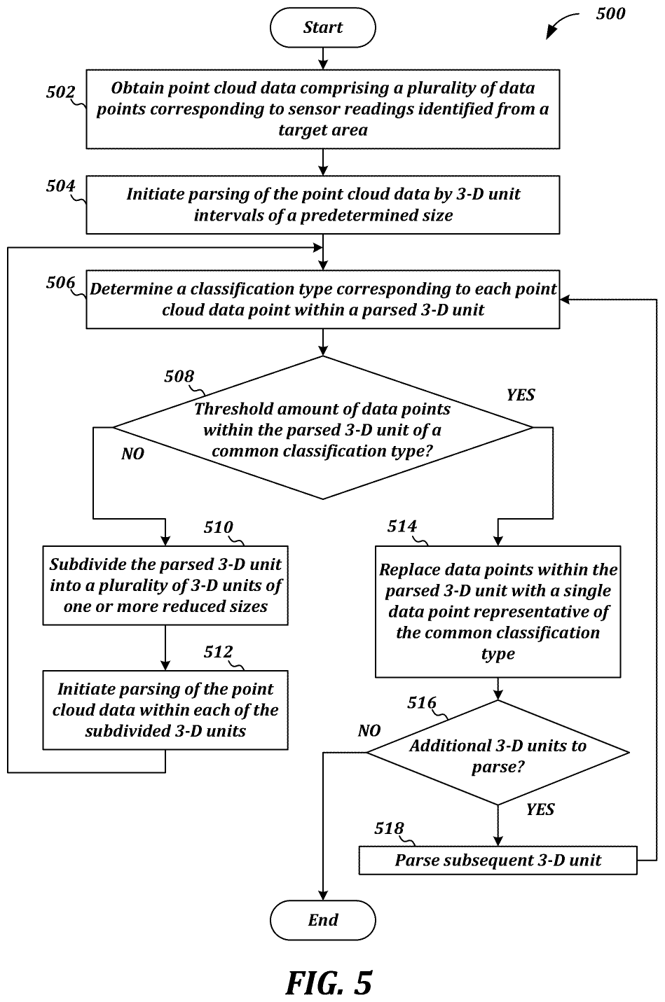

The network design server may perform identification of feasible tower deployment spots based on surface materials, inclination, solar coverage, construction reach, elevation, and other parameters. In one embodiment of the present disclosure, the design server may implement a signal strength modeling based on proprietary signal propagation models in 3-D space including detection of objects and/or their surface classes that can have an effect on signal propagation (e.g., signal blocking, refraction, or absorption). As discussed above, overall signal quality data including signal strength, latency, packet loss, etc., measured in a specific unit of 3-D space overlaid with simultaneous measurements of the density of user devices in that unit of 3-D space may be used. Aspects of the signal quality modeling based on signal propagation models in 3-D space may be discussed in greater detail in connection with the descriptions of FIGS. 5-7.

The network design server may use visual surface characteristics and LiDAR point cloud characteristics provided by an AI/ML module. The design server may optionally rely on direct sourcing from source data (defined relying on third-party LiDAR post-processing applications). In one embodiment of the present disclosure, the network design server may be implemented on a local server, a cloud server, an edge server or a combination thereof. The network design server may be connected to or may host an AI/ML module. The network design server may collect 3-D space map(s) data and 3-D signal map(s) data from the UAS or from ground robotic vehicles equipped with sensors. The network design server may provide enrichments such as derived, deterministic, and/or stochastic data relationships to the AI/ML module. The 3-D space map(s) data and 3-D signal quality map(s) data may be used as machine learning training data sets. The AI/ML module may produce an output as a series of trained network models that have been determined to be suitable for production.

In one embodiment, the network design server may use data related to potential network device profiles (e.g., tower, core, end user device, etc.) as inputs into the AI/ML module. In yet another embodiment, the AI/ML module may generate backhaul capabilities/capacities models as well. These models along with the network design models may be used for network design optimizations. This approach may, advantageously, allow for evaluation of an infinite number of network designs. In one embodiment, the network design server may be implemented as a blockchain peer and may record the network models (or predictive parameters) on a private blockchain discussed in more detail below. In one embodiment the AI/ML module may be configured to output a short list of network designs based on requirements or thresholds.

According to the embodiment of the present disclosure, the AI/ML module may be configured, with respect to the input 3-D mapping data, for pattern recognition of surface planes, corners, curvatures, angular and other characteristics as well as surface types. The AI/ML may be configured to output hybrid 3-D spatial surface outlines optimized for subsequent network design processing.

As discussed above, the network design server may collect 3-D space map(s) data and 3-D signal map(s) data from the UAS or from ground robotic vehicles equipped with sensors. The 3-D maps may be represented by a plethora of vertical planes or by an optimized route dot cloud collected from sensors installed on robotic vehicles. In various embodiments, the vertical planes can include a plurality of random and/or non-random paths or routes over the target area. The AI/ML module may implement data smoothing and interpolation for generation of network models. The AI/ML module may further implement volumization with respect to creation of continuous 3-D spatial outlines of potential backhaul options. In this scenario, the AI/ML module may output 3-D dot clouds specifying spatial outlines of network backhaul options.

The network design server may perform algorithmic modeling of objects by approximating more complex shapes with simpler/standard geometric shapes or, alternatively, irregular blobs (i.e., complex geometric shapes or dense clouds of points) for complex objects). The algorithmic modeling may employ methodology that relies on methods including but not limited to the following:
Object interchange tables providing object replacements. For example, hills are iteratively replaced with prisms, spheres, half-spheres or spherical segments, and half-cylinders; cow barns are replaced with 3-D rectangles with 3-D prism on top; silos are replaced with vertical cylinders; irrigation tanks or water/liquid storage tanks are replaced with horizontal half cylinders or cylinders. Other variations of the shape interchanges may be applied. The design server may evaluate shape errors and may assign the best fitting simpler shapes as final approximations.

In at least one embodiment, the system discussed herein can be operatively configured to perform a discretization algorithm (also referred to herein as “block-splitting”) on 3-D point cloud data. In various embodiments, and as will be discussed in greater detail below in connection with the description of FIG. 5, the system can perform processing steps on 3-D point cloud data to modify how a 3-D space is stored or represented within computer memory such that downstream processing is more efficient and without sacrificing the information quality. In particular embodiments, the quality of information is enhanced and/or optimized in response to the system performing a discretization algorithm, at least due to the system reclassifying a plurality of scattered 3-D point cloud data points into a single data point of a particular class or type.

The design server may perform mathematical modeling of signal propagation such as diffraction, reflection, refraction, absorption, polarization, scattering, etc., caused by the objects in 3-D space. The design server may analyze object surfaces or shapes that dictate signal propagation (transmission and receipt) relying on but not limited to:
1. Custom signal refraction tables previously produced by the ML module and calculations using surface characteristics defined above;
2. RF signal propagation and refraction formulae adjusted with ML-based correction terms previously determined for such surfaces.

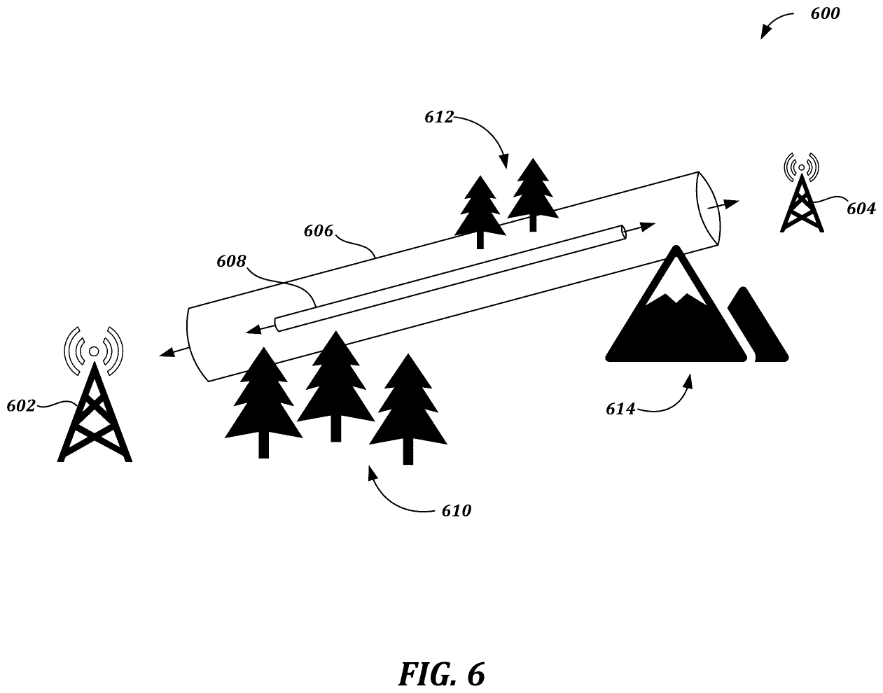

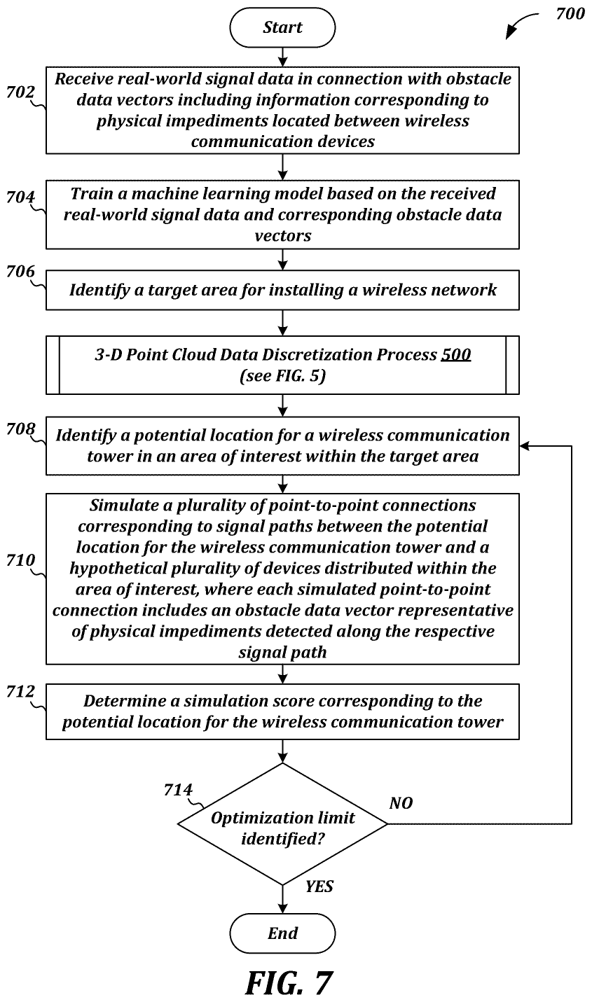

In various embodiments, the system can be configured to evaluate a space between two or more wireless network devices or nodes (e.g., a signal emitter/transmitter, a signal receiver, etc.) for determining a quantity and quality of obstacles or obstructions located between the wireless network devices. As described herein in connection with the discussions of FIGS. 6 and 7, this evaluation can be a tower-to-device, device-to-tower, or point-to-point signal quality analysis, or generally any signal quality analysis of the like. In particular embodiments, the system can simulate wireless signals with various types, sizes, and other characteristics, for determining optimal signal emitter and/or signal receiver positions based on data corresponding to the simulated signals and signal paths.

The design server may use training of multiple ML models (e.g., neural network-based models, which include, but are not limited to Dense, Recurrent, and Convolution layers), which learn to predict signal quality as a function of input parameters or their learned combinations or transformations based on inputs included but not limited to in the following:
1. Directly observed parameters:
   Object types, locations, surfaces, etc.;
   Signal diffraction angles;
   Radio characteristics such as antenna profiles (azimuth and elevation), radio power, radio types/models, switch types/models, amplifier types/models, user device types/models and characteristics, etc.
2. Calculated hypothesis-driven parameters:
   Physical formulae of signal propagation around objects;
   Device characteristics into the RF physics formulae including:
a. Numerous transmitter and receiver relative location and direction parameters used in a network configuration optimization algorithm, which explores an uncountably infinitely-large space of network configurations in a smart fashion using the ML model(s) plus RF-design vs cost implications of potential backhaul location choices (main vector plus signal dissipation functions around it) to evaluate coverage quality and to guide the search for an optimal or a near-optimal solution. Possible options include, but are not limited to Linear Programming, Generic Algorithm, Reinforcement learning.
b. Identification of top solution(s):
i. Finding a configuration of the best or near-best coverage, given a fixed budget and/or other optimization requirements;
ii. Finding a configuration with the minimum or near-minimum cost, which provides minimum desired quality of coverage in a target area;
iii. Given a relative cost-to-coverage-quality trade-off, finding a configuration which optimizes both objectives (cost and coverage) at once.

The design server may generate a final design based on cost selection by customers.

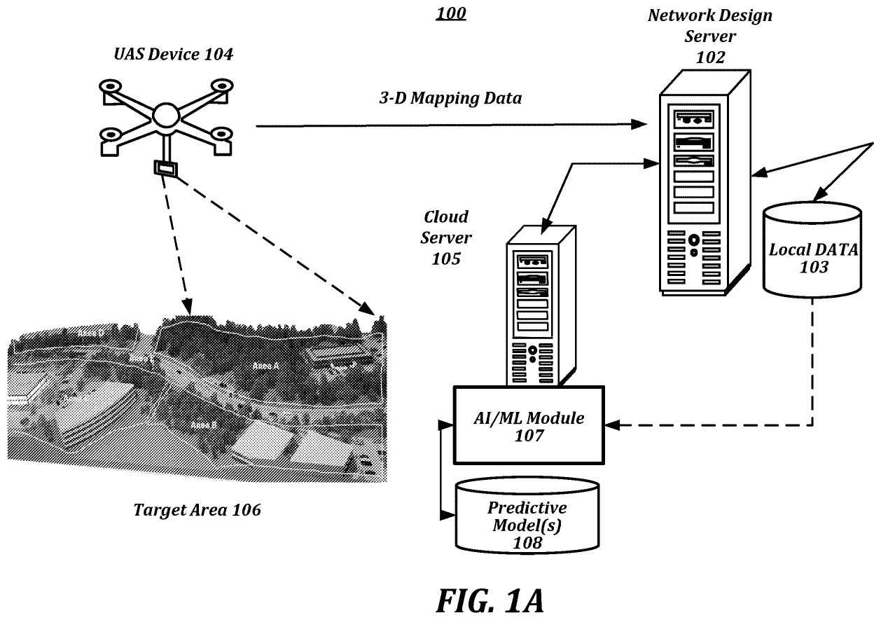

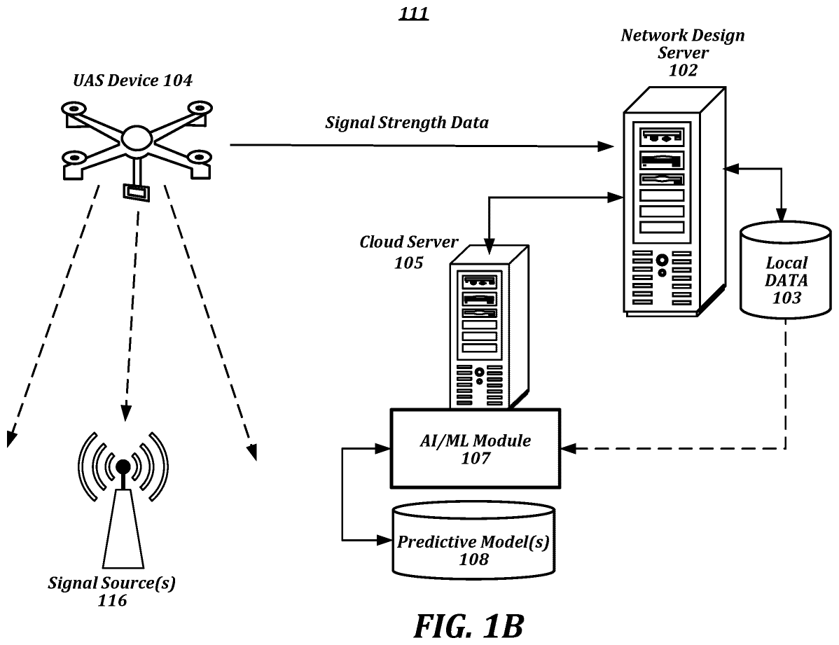

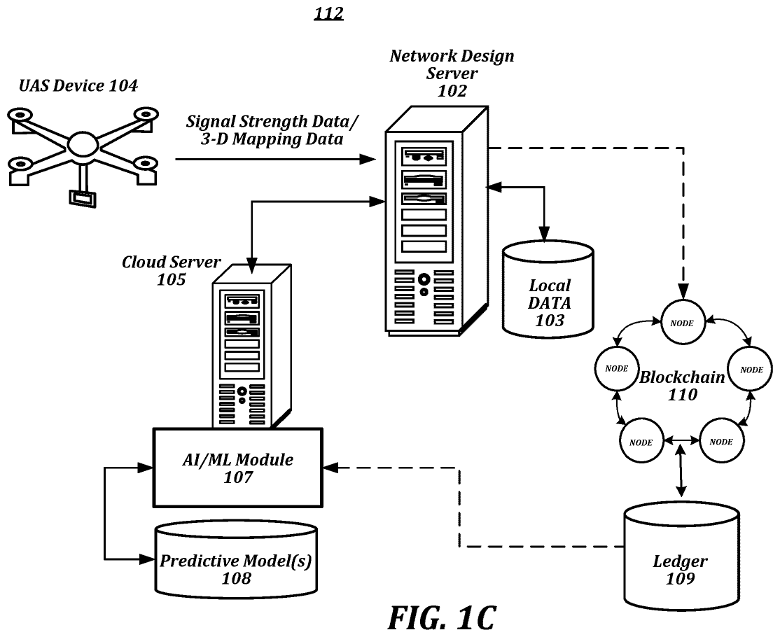

FIG. 1A illustrates a network diagram of a system for ML-based network design process employing photogrammetry surveillance data consistent with the present disclosure.

Referring to FIG. 1A, the example network 100 includes the design server node 102 connected to a cloud server node(s) 105 over a network. The cloud server node(s) 105 is configured to host an AI/ML module 107. The design server node 102 may receive 3-D mapping data from an UAS device 104 that flies over a target area 106 and collects data using video and/or sensory equipment. As discussed above, the UAS device 104 may collect photogrammetry data, LiDAR data and thermal imagery data which is derived via methods including but not limited to Photogrammerty, Radiometry, Photometry, Laser Scanning, etc. and a combination thereof.

The AI/ML module 107 may generate a predictive model(s) 108 based on historical network design-related data provided by the design server 102 from a local data storage 103 and based on the 3-D mapping data. The AI/ML module 107 may provide predictive outputs data that indicate locations and types of towers that are most optimal for the surveyed target area 106. Note that the AI/ML module 107 may be implemented on the design server node 102. The design server node 102 may process the predictive outputs data received from the AI/ML module 107 to generate a final network design for the target area 106. The AI/ML module 107 may use historical data that reflects previously studied and modeled dependencies. In one embodiment, the historical data may be recorded on a ledger of a private blockchain discussed in more detail below.

FIG. 1B illustrates a network diagram of a system for ML-based network design process employing signal strength data consistent with the present disclosure.

Referring to FIG. 1B, the example network 111 includes the design server node 102 connected to a cloud server node(s) 105 over a network. The cloud server node(s) 105 is configured to host an AI/ML module 107. The design server node 102 may receive signal strength data from the UAS device 104 that flies over a target area that has a signal source(s) 116 located within the target area and collects signal strength data using signal measurement equipment. The UAS device 104 may employ “slices” or “planes”—i.e., measured vertical flight planes (funnels) spaced away from each other at standard distances to be flown. In one embodiment, the UAS device 204 may employ horizontal, diagonal or other fight planes for collecting 3-D signal strength data. In yet another embodiment, the UAS 204 may employ a flight path predicted by the ML model, which may not be made of simple geometric forms. In one embodiment, a signal quality may be analyzed. The signal quality may include signal strength, latency and packet loss measured in a specific unit of 3-D space overlaid with simultaneous measurements of the density of user devices in that unit of 3-D space.

The AI/ML module 107 may be configured to implement ML/regression modeling of a signal strength in each funnel within each plane. The design server node 102 may determine usable signal strength area definition within each plane as well as usable signal strength area definition in 3-D space using smart interpolation that may be implemented by the AI/ML module 107.

The AI/ML module 107 may generate a predictive model(s) 108 based on historical network design-related data provided by the design server 102 from a local data storage 103 and based on the signal strength. The AI/ML module 107 may provide predictive outputs data that indicate locations, orientations and types of towers that are most optimal for the surveyed target area 106. Note that the AI/ML module 107 may be implemented on the design server node 102. The design server node 102 may process the predictive outputs data received from the AI/ML module 107 to generate a complete network design for the target area 106.

FIG. 1C illustrates a network diagram of a system for ML-based network design process employing surveillance data and a blockchain network consistent with the present disclosure.

Referring to FIG. 1C, the example network 112 includes the design server node 102 connected to a cloud server node(s) 105 over a network. The cloud server node(s) 105 is configured to host an AI/ML module 107. The design server node 102 may receive surveillance data including signal strength data and 3-D mapping data from the UAS device 104 that flies over a target area and collects data using signal measurement equipment and video/LiDAR/thermal imagery equipment. As discussed above, the UAS device 104 may employ vertical planes (funnels) to be flown. The signal measurements in the funnels are implemented as sequential steps. The signal measurement data from each step may be recorded on a private blockchain 110. In this implementation the design server 102 and the cloud server 105 may server as blockchain 110 peer nodes. In one embodiment, the UAS device 104 may serve as a dynamic blockchain peer node as well. Note that signal quality data may be used instead of signal strength data. The signal quality data may include signal strength, latency and packet loss measured in a specific unit of 3-D space overlaid with simultaneous measurements of the density of user devices in that unit of 3-D space.

The AI/ML module 107 may be configured to implement ML/regression modeling of signal strength in each funnel within each flight plane. The design server node 102 may determine usable signal strength area definition within each plane as well as usable signal strength area definition in 3-D space using smart interpolation. The AI/ML module 107 may generate a predictive model(s) 108 based on historical network design-related data provided by the design server 102 from a local data storage 103, based on the photogrammetry data and the signal strength acquired from a blockchain ledger 109. As discussed above, the AI/ML module 107 may provide predictive outputs data that indicate locations, orientations and types of towers that are most optimal for the surveyed target area 106. Note that the AI/ML module 107 may be implemented on the design server node 102. The design server node 102 may process the predictive outputs data received from the AI/ML module 107 to generate a final network design for the target area 106.

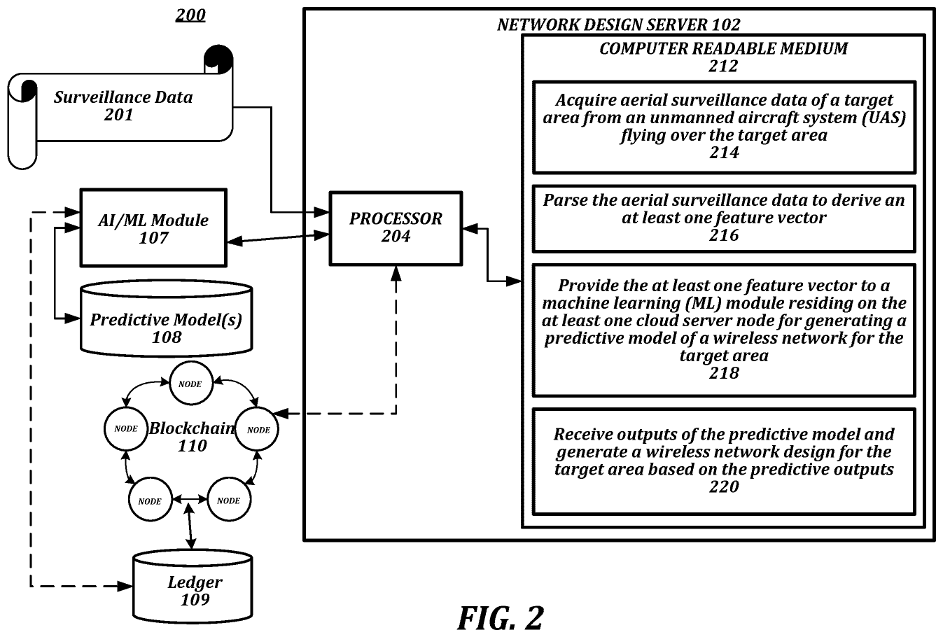

FIG. 2 illustrates a network diagram of a system including detailed features of a design server node consistent with the present disclosure.

Referring to FIG. 2, the example network 200 includes the design server node 102

102 connected to a cloud server node(s) 105 over a network. The cloud server node(s) 105 is configured to host an AI/ML module 107. As discussed above with reference to FIG. 1C, the design server node 102 may receive surveillance data including signal strength data and 3-D mapping data from the UAS device 104 that flies over a target area and collects data.

The AI/ML module 107 may generate a predictive model(s) 108 based on historical network design-related data provided by the design server 102 from a local data storage 103, based on the surveillance data (i.e., the 3-D data and the signal strength data). The signal strength data may be recorded on a permissioned blockchain 110 ledger 109. As discussed above, the AI/ML module 107 may provide predictive outputs data that indicate network design parameters (e.g., locations, equipment orientations, vendors, models, configuration settings, and types of towers) that are most optimal for the surveyed target area. Note that the AI/ML module 107 may be implemented on the design server node 102 (not shown). The design server node 102 may process the predictive outputs data received from the AI/ML module 107 to generate a final network design for the target area 106. The AI/ML module 107 may be configured to codify deterministic and/or stochastic base relationships characterizing known profiles/behaviors of any RF and other electronic elements that may be used in the target network design.

While this example describes in detail only one design server node 102, multiple such nodes may be connected to the network and to the blockchain 110. It should be understood that the design server node 102 may include additional components and that some of the components described herein may be removed and/or modified without departing from a scope of the design server node 102 disclosed herein. The design server node 102 may be a computing device or a server computer, or the like, and may include a processor 204, which may be a semiconductor-based microprocessor, a central processing unit (CPU), an application specific integrated circuit (ASIC), a field-programmable gate array (FPGA), and/or another hardware device. Although a single processor 204 is depicted, it should be understood that the design server node 102 may include multiple processors, multiple cores, or the like, without departing from the scope of the design server node 102 system.

The design server node 102 may also include a non-transitory computer readable medium 212 that may have stored thereon machine-readable instructions executable by the processor 204. Examples of the machine-readable instructions are shown as 214-220 and are further discussed below. Examples of the non-transitory computer readable medium 212 may include an electronic, magnetic, optical, or other physical storage device that contains or stores executable instructions. For example, the non-transitory computer readable medium 212 may be a Random-Access memory (RAM), an Electrically Erasable Programmable Read-Only Memory (EEPROM), a hard disk, an optical disc, or other type of storage device.

The processor 204 may fetch, decode, and execute the machine-readable instructions 214 to acquire aerial surveillance data of a target area from an unmanned aircraft system (UAS) flying over the target area. The processor 204 may fetch, decode, and execute the machine-readable instructions 216 to parse the aerial surveillance data to derive an at least one feature vector. The processor 204 may fetch, decode, and execute the machine-readable instructions 218 to provide the at least one feature vector to a machine learning (ML) module residing on the at least one cloud server node for generating a predictive model of a wireless network for the target area. The processor 204 may fetch, decode, and execute the machine-readable instructions 222 to receive a plurality of outputs of the predictive model and to generate a wireless network design for the target area based on the plurality of the predictive outputs. The permissioned blockchain 110 may be configured to use one or more smart contracts that manage transactions for multiple participating nodes.

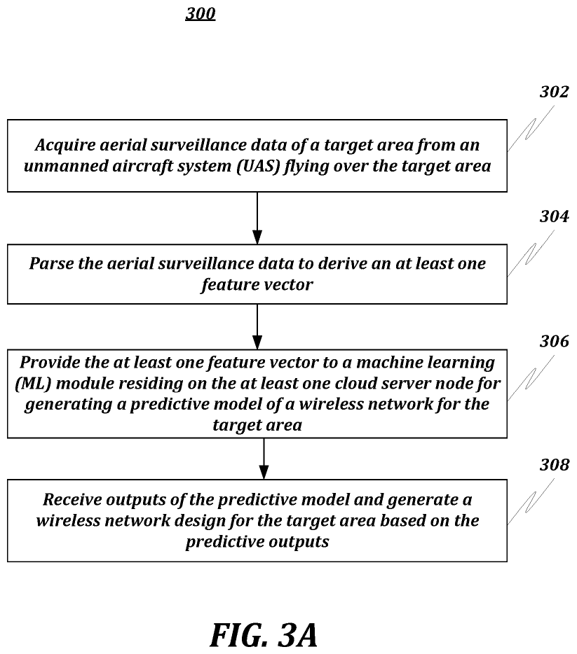

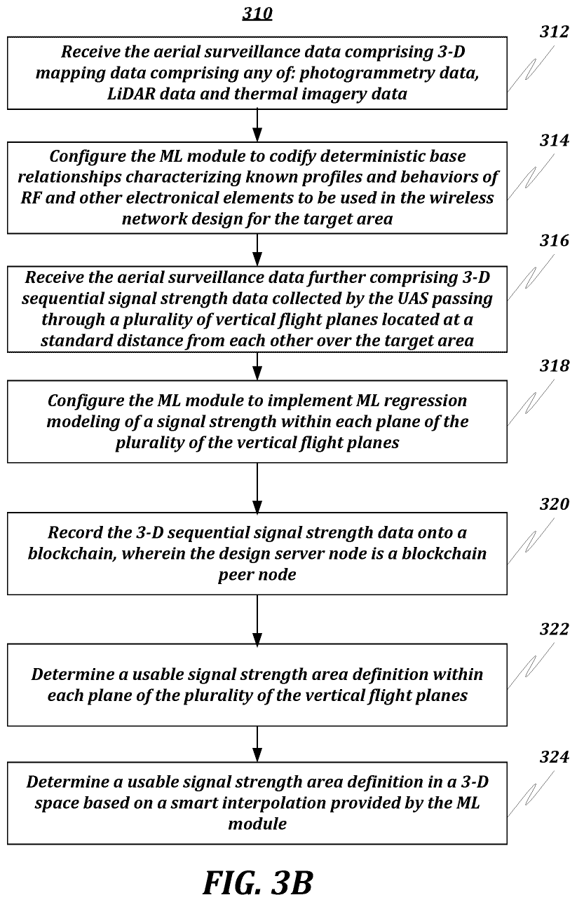

FIG. 3A illustrates a flowchart of a method for ML-based network design and optimization of the design processing consistent with the present disclosure.

Referring to FIG. 3A, the method 300 may include one or more of the steps described below. FIG. 3A illustrates a flow chart of an example method executed by the design server 102 (see FIG. 2). It should be understood that method 300 depicted in FIG. 3A may include additional operations and that some of the operations described therein may be removed and/or modified without departing from the scope of the method 300. The description of the method 300 is also made with reference to the features depicted in FIG. 2 for purposes of illustration. Particularly, the processor 204 of the design server 102 may execute some or all of the operations included in the method 300.

With reference to FIG. 3A, at block 302, the processor 204 may acquire aerial surveillance data of a target area from an unmanned aircraft system (UAS) flying over the target area. At block 304, the processor 204 may parse the aerial surveillance data to derive an at least one feature vector. At block 306, the processor 204 may provide the at least one feature vector to a machine learning (ML) module residing on the at least one cloud server node for generating a predictive model of a wireless network for the target area. At block 308, the processor 204 may receive outputs of the predictive model and may generate a wireless network design for the target area based on the predictive outputs.

FIG. 3B illustrates a further flowchart of a method for ML-based network design and optimization of the design processing consistent with the present disclosure. Referring to FIG. 3B, the method 310 may include one or more of the steps described below. FIG. 3B illustrates a flow chart of an example method executed by the design server 102 (see FIG. 2). It should be understood that method 310 depicted in FIG. 3B may include additional operations and that some of the operations described therein may be removed and/or modified without departing from the scope of the method 310. The description of the method 310 is also made with reference to the features depicted in FIG. 2 for purposes of illustration. Particularly, the processor 204 of the design server 102 may execute some or all of the operations included in the method 300.

With reference to FIG. 3B, at block 312, the processor 204 may receive the aerial surveillance data comprising 3-D mapping data comprising any of but not limited to: photogrammetry data, LiDAR data and thermal imagery data. At block 314, the processor 204 may configure the ML module to codify deterministic and/or stochastic base relationships characterizing known profiles and behaviors of RF and other electronic elements to be used in the wireless network design for the target area.

At block 316, the processor 204 may receive the aerial surveillance data further comprising 3-D sequential signal strength data collected by the UAS passing through a plurality of vertical flight planes located at a standard distance from each other and/or an algorithmically determined non-linear path specified as a set of waypoints over some or all of the target area. At block 318, the processor 204 may configure the ML module to implement ML regression modeling of a signal strength within each plane of the plurality of the vertical flight planes. In one embodiment, ML module may use an underlying neural network for modeling of signal quality indicators such as the signal strength. The ML module may use a combination of deterministic formulae, stochastic formulae, as well as machine-learned independent-dependent variable relationships.

At block 320, the processor 204 may record the 3-D sequential signal strength data onto a blockchain, wherein the design server node is a blockchain peer node. At block 322, the processor 204 may determine a usable signal strength area definition within each plane of the plurality of the vertical flight planes. The process may use each cubic unit of space within the planes depending on precision requirements.

At block 324, the processor 204 may determine a usable signal strength area definition in a 3-D space based on a custom-algorithm interpolation provided by the ML module. The ML module may provide direct predictive calculations for a plethora of cubic units of space, or any combination thereof. Selection of a method to be used and/or method weight may be based on context-driven criteria determined to lead to most accurate results and optimal network designs. As discussed above, overall signal quality data may be collected. The signal quality data may include signal strength, latency, packet loss, signal-to-noise ratio, etc., measured in a specific unit of 3-D space overlaid with simultaneous measurements of the density of user devices in that unit of 3-D space.

The above embodiments of the present disclosure may be implemented in hardware, in a computer-readable instructions executed by a processor, in firmware, or in a combination of the above. The computer computer-readable instructions may be embodied on a computer-readable medium, such as a storage medium. For example, the computer computer-readable instructions may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

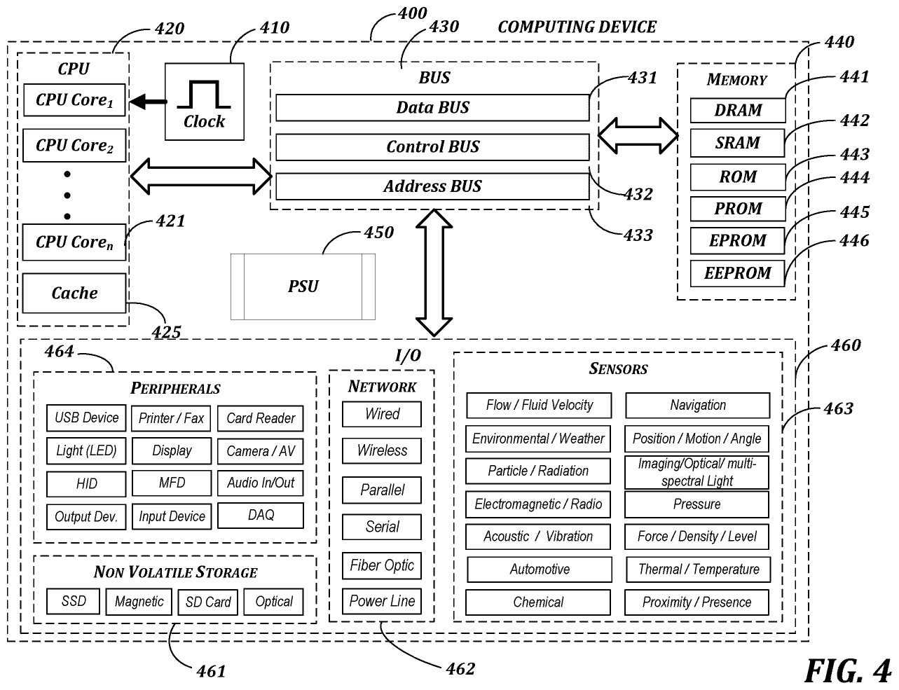

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative embodiment, the processor and the storage medium may reside as discrete components. For example, FIG. 4 illustrates an example computing device (e.g., a server node) 400, which may represent or be integrated in any of the above-described components, etc.

FIG. 4 illustrates a block diagram of a system including computing device 400. The computing device 400 may comprise, but not be limited to the following:

Mobile computing device, such as, but is not limited to, a laptop, a tablet, a smartphone, a drone, a wearable, an embedded device, a handheld device, an Arduino, an industrial device, or a remotely operable recording device;

A supercomputer, an exa-scale supercomputer, a mainframe, or a quantum computer;

A minicomputer, wherein the minicomputer computing device comprises, but is not limited to, an IBM AS400/iSeries/System I, A DEC VAX/PDP, a HP3000, a Honeywell-Bull DPS, a Texas Instruments TI-990, or a Wang Laboratories VS Series;

A microcomputer, wherein the microcomputer computing device comprises, but is not limited to, a server, wherein a server may be rack mounted, a workstation, an industrial device, a raspberry pi, a desktop, or an embedded device;

The design server node 102 (see FIG. 2) may be hosted on a centralized server or on a cloud computing service. Although method 300 has been described to be performed by the design server node 102 implemented on a computing device 400, it should be understood that, in some embodiments, different operations may be performed by a plurality of the computing devices 400 in operative communication at least one network.

Embodiments of the present disclosure may comprise a computing device having a central processing unit (CPU) 420, a bus 430, a memory unit 440, a power supply unit (PSU) 450, and one or more Input/Output (I/O) units. The CPU 420 coupled to the memory unit 440 and the plurality of I/O units 460 via the bus 430, all of which are powered by the PSU 450. It should be understood that, in some embodiments, each disclosed unit may actually be a plurality of such units for the purposes of redundancy, high availability, and/or performance. The combination of the presently disclosed units is configured to perform the stages any method disclosed herein.

Consistent with an embodiment of the disclosure, the aforementioned CPU 420, the bus 430, the memory unit 440, a PSU 450, and the plurality of I/O units 460 may be implemented in a computing device, such as computing device 400. Any suitable combination of hardware, software, or firmware may be used to implement the aforementioned units. For example, the CPU 420, the bus 430, and the memory unit 440 may be implemented with computing device 400 or any of other computing devices 400, in combination with computing device 400. The aforementioned system, device, and components are examples and other systems, devices, and components may comprise the aforementioned CPU 420, the bus 430, the memory unit 440, consistent with embodiments of the disclosure.

At least one computing device 400 may be embodied as any of the computing elements illustrated in all of the attached figures, including the design server node 102 (FIG. 2). A computing device 400 does not need to be electronic, nor even have a CPU 420, nor bus 430, nor memory unit 440. The definition of the computing device 400 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 400, especially if the processing is purposeful.

With reference to FIG. 4, a system consistent with an embodiment of the disclosure may include a computing device, such as computing device 400. In a basic configuration, computing device 400 may include at least one clock module 410, at least one CPU 420, at least one bus 430, and at least one memory unit 440, at least one PSU 450, and at least one I/O 460 module, wherein I/O module may be comprised of, but not limited to a non-volatile storage sub-module 461, a communication sub-module 462, a sensors sub-module 463, and a peripherals sub-module 464.

A system consistent with an embodiment of the disclosure the computing device 400 may include the clock module 410 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 420, the central component of modern computers, which relies on a clock. The only exceptions are asynchronous circuits such as asynchronous CPUs. The clock 410 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 4 wires.

Many computing devices 400 use a “clock multiplier” which multiplies a lower frequency external clock to the appropriate clock rate of the CPU 420. This allows the CPU 420 to operate at a much higher frequency than the rest of the computer, which affords performance gains in situations where the CPU 420 does not need to wait on an external factor (like memory 440 or input/output 460). Some embodiments of the clock 410 may include dynamic frequency change, where, the time between clock edges can vary widely from one edge to the next and back again.

A system consistent with an embodiment of the disclosure the computing device 400 may include the CPU unit 420 comprising at least one CPU Core 421. A plurality of CPU cores 421 may comprise identical CPU cores 421, such as, but not limited to, homogeneous multi-core systems. It is also possible for the plurality of CPU cores 421 to comprise different CPU cores 421, such as, but not limited to, heterogeneous multi-core systems, big.LITTLE systems and some AMD accelerated processing units (APU). The CPU unit 420 reads and executes program instructions which may be used across many application domains, for example, but not limited to, general purpose computing, embedded computing, network computing, digital signal processing (DSP), and graphics processing (GPU). The CPU unit 420 may run multiple instructions on separate CPU cores 421 at the same time. The CPU unit 420 may be integrated into at least one of a single integrated circuit die and multiple dies in a single chip package. The single integrated circuit die and multiple dies in a single chip package may contain a plurality of other aspects of the computing device 400, for example, but not limited to, the clock 410, the CPU 420, the bus 430, the memory 440, and I/O 460.

The CPU unit 420 may contain cache 422 such as, but not limited to, a level 1 cache, level 2 cache, level 3 cache or combination thereof. The aforementioned cache 422 may or may not be shared amongst a plurality of CPU cores 421. The cache 422 sharing comprises at least one of message passing and inter-core communication methods may be used for the at least one CPU Core 421 to communicate with the cache 422. The inter-core communication methods may comprise, but not limited to, bus, ring, two-dimensional mesh, and crossbar. The aforementioned CPU unit 420 may employ symmetric multiprocessing (SMP) design.

The plurality of the aforementioned CPU cores 421 may comprise soft microprocessor cores on a single field programmable gate array (FPGA), such as semiconductor intellectual property cores (IP Core). The plurality of CPU cores 421 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 421, for example, but not limited to Instruction-level parallelism (ILP) such as, but not limited to, superscalar pipelining, and Thread-level parallelism (TLP).

Consistent with the embodiments of the present disclosure, the aforementioned computing device 400 may employ a communication system that transfers data between components inside the aforementioned computing device 400, and/or the plurality of computing devices 400. The aforementioned communication system will be known to a person having ordinary skill in the art as a bus 430. The bus 430 may embody internal and/or external plurality of hardware and software components, for example, but not limited to a wire, optical fiber, communication protocols, and any physical arrangement that provides the same logical function as a parallel electrical bus. The bus 430 may comprise at least one of, but not limited to a parallel bus, wherein the parallel bus carry data words in parallel on multiple wires, and a serial bus, wherein the serial bus carry data in bit-serial form. The bus 430 may embody a plurality of topologies, for example, but not limited to, a multidrop/electrical parallel topology, a daisy chain topology, and a connected by switched hubs, such as USB bus. The bus 430 may comprise a plurality of embodiments, for example, but not limited to:
Internal data bus (data bus) 431/Memory bus
Control bus 432
Address bus 433
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect extended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper {Cu} Link]), Express Card, AdvancedTCA, AMC, Universal 10, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and extensible Host Controller Interface (xHCI).

Consistent with the embodiments of the present disclosure, the aforementioned computing device 400 may employ hardware integrated circuits that store information for immediate use in the computing device 400, know to the person having ordinary skill in the art as primary storage or memory 440. The memory 440 operates at high speed, distinguishing it from the non-volatile storage sub-module 461, which may be referred to as secondary or tertiary storage, which provides slow-to-access information but offers higher capacities at lower cost. The contents contained in memory 440, may be transferred to secondary storage via techniques such as, but not limited to, virtual memory and swap. The memory 440 may be associated with addressable semiconductor memory, such as integrated circuits consisting of silicon-based transistors, used for example as primary storage but also other purposes in the computing device 400. The memory 440 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 441, Static Random-Access Memory (SRAM) 442, CPU Cache memory 425, Advanced Random-Access Memory (A-RAM), and other types of primary storage such as Random-Access Memory (RAM).
Non-volatile memory which can retain stored information even after power is removed, for example, but not limited to, Read-Only Memory (ROM) 443, Programmable ROM (PROM) 444, Erasable PROM (EPROM) 445, Electrically Erasable PROM (EEPROM) 446 (e.g., flash memory and Electrically Alterable PROM [EAPROM]), Mask ROM (MROM), One Time Programable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3-D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).
Consistent with the embodiments of the present disclosure, the aforementioned computing device 400 may employ the communication system between an information processing system, such as the computing device 400, and the outside world, for example, but not limited to, human, environment, and another computing device 400. The aforementioned communication system will be known to a person having ordinary skill in the art as I/O 460. The I/O module 460 regulates a plurality of inputs and outputs with regard to the computing device 400, wherein the inputs are a plurality of signals and data received by the computing device 400, and the outputs are the plurality of signals and data sent from the computing device 400. The I/O module 460 interfaces a plurality of hardware, such as, but not limited to, non-volatile storage 461, communication devices 462, sensors 463, and peripherals 464. The plurality of hardware is used by the at least one of, but not limited to, human, environment, and another computing device 400 to communicate with the present computing device 400. The I/O module 460 may comprise a plurality of forms, for example, but not limited to channel I/O, port mapped I/O, asynchronous I/O, and Direct Memory Access (DMA).
Consistent with the embodiments of the present disclosure, the aforementioned computing device 400 may employ the non-volatile storage sub-module 461, which may be referred to by a person having ordinary skill in the art as one of secondary storage, external memory, tertiary storage, off-line storage, and auxiliary storage. The non-volatile storage sub-module 461 may not be accessed directly by the CPU 420 without using intermediate area in the memory 440. The non-volatile storage sub-module 461 does not lose data when power is removed and may be two orders of magnitude less costly than storage used in memory module, at the expense of speed and latency. The non-volatile storage sub-module 461 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (461) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD+RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the aforementioned computing device 400 may employ the communication sub-module 462 as a subset of the I/O 460, which may be referred to by a person having ordinary skill in the art as at least one of, but not limited to, computer network, data network, and network. The network allows computing devices 400 to exchange data using connections, which may be known to a person having ordinary skill in the art as data links, between network nodes. The nodes comprise network computer devices 400 that originate, route, and terminate data. The nodes are identified by network addresses and can include a plurality of hosts consistent with the embodiments of a computing device 400. The aforementioned embodiments include, but not limited to personal computers, phones, servers, drones, and networking devices such as, but not limited to, hubs, switches, routers, modems, and firewalls.

Two nodes can be said are networked together, when one computing device 400 is able to exchange information with the other computing device 400, whether or not they have a direct connection with each other. The communication sub-module 462 supports a plurality of applications and services, such as, but not limited to World Wide Web (WWW), digital video and audio, shared use of application and storage computing devices 400, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 462 may comprise a plurality of size, topology, traffic control mechanism and organizational intent. The communication sub-module 462 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 4G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line and wireless communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 400 may employ the sensors sub-module 463 as a subset of the I/O 460. The sensors sub-module 463 comprises at least one of the devices, modules, and subsystems whose purpose is to detect events or changes in its environment and send the information to the computing device 400. Sensors are sensitive to the measured property, are not sensitive to any property not measured, but may be encountered in its application, and do not significantly influence the measured property. The sensors sub-module 463 may comprise a plurality of digital devices and analog devices, wherein if an analog device is used, an Analog to Digital (A-to-D) converter must be employed to interface the said device with the computing device 400. The sensors may be subject to a plurality of deviations that limit sensor accuracy. The sensors sub-module 463 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:

Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).

Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, LIDAR, multi-spectral light sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 400 may employ the peripherals sub-module 462 as a subset of the I/O 460. The peripheral sub-module 464 comprises ancillary devices uses to put information into and get information out of the computing device 400. There are 3 categories of devices comprising the peripheral sub-module 464, which exist based on their relationship with the computing device 400, input devices, output devices, and input/output devices. Input devices send at least one of data and instructions to the computing device 400. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 400. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 464:

### Input Devices

Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
High degree of freedom devices, that require up to six degrees of freedom such as, but not limited to, camera gimbals, Cave Automatic Virtual Environment (CAVE), and virtual reality systems.
Video Input devices are used to digitize images or video from the outside world into the computing device 400. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3-D scanner, laser rangefinder, eye gaze tracker, computed tomography, magnetic resonance imaging, positron emission tomography, medical ultrasonography, TV tuner, and iris scanner.
Audio input devices are used to capture sound. In some cases, an audio output device can be used as an input device, in order to capture produced sound. Audio input devices allow a user to send audio signals to the computing device 400 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
Data Acquisition (DAQ) devices convert at least one of analog signals and physical parameters to digital values for processing by the computing device 400. Examples of DAQ devices may include, but not limited to, Analog to Digital Converter (ADC), data logger, signal conditioning circuitry, multiplexer, and Time to Digital Converter (TDC). Output Devices may further comprise, but not be limited to:
Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).

Printers, such as, but not limited to, inkjet printers, laser printers, 3-D printers, solid ink printers and plotters.
Audio and Video (AV) devices, such as, but not limited to, speakers, headphones, amplifiers and lights, which include lamps, strobes, DJ lighting, stage lighting, architectural lighting, special effect lighting, and lasers.
Other devices such as Digital to Analog Converter (DAC)

Input/Output Devices may further comprise, but not be limited to, touchscreens, networking device (e.g., devices disclosed in network 462 sub-module), data storage device (non-volatile storage 461), facsimile (FAX), and graphics/sound cards.

Turning now to FIG. 5, a flowchart of an example process 500 for point cloud data discretization is shown, according to one aspect of the present disclosure. In at least one embodiment, and for generating intelligent wireless network designs, the system receives large quantities of data corresponding to physical characteristics of a target area in which a wireless network may be installed. For example, the system can use LiDAR sensors to receive this data, and LiDAR sensors can generate millions of data points per second. Further, scanning a target area can take several minutes (if not several hours). However, much of a 3-D point cloud (for example, as captured via a LiDAR sensor) includes redundant sensor readings which can result in inefficient processing when identifying specific changes in an area's topography and/or physical characteristics. In one embodiment, the example process 500 describes a method for discretizing or redescribing a 3-D point cloud by converting 3-D volumes of similarly classified point cloud data into a homogenous space.

In various embodiments, the example process 500 begins at step 502 where the system obtains point cloud data comprising a plurality of data points corresponding to sensor readings identified from a target area. As discussed herein, the point cloud data can be scanned from one or more sensors on a UAS flying above the target area. The point cloud data can be scanned from, or obtained by, generally any appropriate signal detection device. Furthermore, in certain embodiments, the signal detection device for obtaining the point cloud data need not be installed on a UAS flying above the target area, but instead can be obtained by any signal detection device in a sufficiently elevated position for capturing aerial surveillance data (such as via a person carrying the signal detection device, via hoisting or raising the device from ground level, via launching the device as a projectile above/over the target area, via a non-UAS vehicle, etc.).

At step 504, the system initiates parsing of the point cloud data. In various embodiments, parsing of the point cloud data includes iterating through the point cloud data in 3-D unit intervals of a predetermined size/volume, and subsequently processing and evaluating the point cloud data points included within the 3-D units. In certain embodiments, the 3-D volumes, or units, may be any shape or size (regular or irregular). According to various aspects of the present disclosure, the system may be configured such that a default 3-D unit size is based on 1-meter dimensions (length, width, and height); however, the 3-D unit size may be based on the point cloud data to be processed. For example, the predetermined 3-D unit size dimensions may be increased to 2 meters, 5 meters, 10 meters, etc., for areas in which the detected physical characteristics are generally uniform. In particular embodiments, the 3-D units may be right parallelepiped. In certain embodiments, the 3-D units may be cubes. In one embodiment, the 3-D unit may be any shape that allows for three-dimensional tessellation.

At step 506, the system determines a type or classification corresponding to each point cloud data point within a parsed 3-D unit. According to various aspects of the present disclosure, a point cloud data point type may be vegetation, buildings, terrain, water volumes, surface object types—i.e., brick buildings vs. glass or steel, etc. In at least one embodiment, the point cloud data point types may be predetermined such that the system can include a memory of different objects detected in prior scans, and the system can correlate or match subsequent point cloud data points with these historical and known point cloud data point types. Moreover, the system can determine, based on known characteristics about LiDAR signals and/or the reflected light detected during LiDAR scanning (or based on any other type of appropriate signal), what type of object a LiDAR sensor is scanning based on the characteristics of the reflected light received. The system can also be configured to leverage known characteristics of visual spectrum imagery for determining a type or classification corresponding to each point cloud data point. For example, the system can be configured to map point cloud data points to values corresponding to visual spectrum scans (e.g., detected frequencies, intensities, etc.), and the system can compare the mapped point cloud data to historical and known point cloud data point types.

At step 508, the system determines whether each point cloud data point within the parsed 3-D unit is of a common classification type. For example, at step 508, the system can determine whether each point cloud data point within a right-parallelepiped 3-D unit is indicative of vegetation, water, steel, rock, air, etc. If one or more point cloud data points within the parsed 3-D unit are dissimilar from the entirety of the point cloud data points in the 3-D unit, the process 500 can proceed to step 510. However, it should be understood from the discussion herein that in various embodiments, the system can be configured to tolerate a predetermined amount or threshold of uncommon classifications in a 3-D unit. For example, the system can be configured to indicate a 3-D unit as including point cloud data points of a common classification type despite 1%, 2%, 3%, 4%, 5%, 10%, etc., or any appropriate threshold amount or value of the point cloud data points being of an uncommon type. In certain embodiments, the system can be configured to assign weights to various classification types for various scenarios. For example, in a scenario where 90% of the point cloud data points in a 3-D unit are representative of water, the system can tolerate 10% of non-water classification types given the 3-D unit, despite including the 10% of non-water classified data points, likely represents a flat water surface with limited obstacles or irregularities (and thus water-classified points are heavily weighted in favor of characteristic predictability). However, the system can be configured to tolerate lower (or higher) irregularity thresholds, for example, where point cloud data points include mostly rock, steel, and vegetation.

In one embodiment, at step 510 the system can subdivide the parsed 3-D unit into a plurality of smaller 3-D units. In various embodiments, subdividing the parsed 3-D unit into a plurality of smaller 3-D units can include halving the 3-D unit across each dimension (splitting a single unit into eight equally sized and proportionally shaped 3-D units). In a particular embodiment, the subdivided 3-D units can include a shape that is similar to their respective former and larger 3-D unit. The plurality of smaller 3-D units can be equally sized, or the plurality of smaller 3-D units can include various sizes, shapes, and volumes.

In particular embodiments, at step 512, the system can initiate parsing of the point cloud data within each of the subdivided 3-D units. In various embodiments, the parsing at step 512 can resemble the parsing executed at step 504; however, the parsing initiated at step 512 occurs on the subdivided 3-D units until the subdivided 3-D units have been fully parsed.

Referring back to step 508, if each data point within the parsed 3-D unit is of a common classification type, the process 500 can proceed to step 514. In various embodiments, at step 514, the system can replace the data points within the parsed 3-D unit with a single data point representative of the common classification type. In one embodiment, the single data point representative of the common classification type can be positioned at the center of the parsed 3-D unit.

At step 516, the system can determine if there are additional 3-D units to parse (either of the predetermined size or of a subdivided size). If there are additional 3-D units to parse, the process 500 proceeds to step 518 where the system proceeds to parse a subsequent 3-D unit of the point cloud data. If there are no additional 3-D units to parse, the process 500 can end.

In various embodiments, FIG. 6 is a diagram of an example environment 600 illustrating tower-to-device signal quality analysis, according to one aspect of the present disclosure. It should be understood from the discussion herein that, notwithstanding referring to the example environment 600 as illustrating tower-to-device signal quality analysis, the example environment 600 generally illustrates tower-to-device, device-to-tower, point-to-point signal quality analysis, and the like, according to various aspects of the present disclosure. In at least one embodiment, the example environment 600 illustrates how the system is operatively configured to evaluate and analyze potential wireless communication tower locations in an area of interest based on simulated point-to-point signal paths. In various embodiments, the simulated point-to-point signal paths can be represented as cylinders (also referred to herein as “cylinder rays”) within the discretized 3-D space generated via the process 500. In one example, the cylinders can correspond to data vectors, where the data vectors include discretized point cloud data points intercepted along the point-to-point signal path.

As shown in the example environment 600 of FIG. 6, the present embodiment includes a first wireless communication device 602 and a second wireless communication device 604. In various embodiments, and for purposes of example, the first wireless communication device 602 can be a wireless signal emitter and the second wireless communication device 604 can be a wireless signal receiver. However, it should be understood that both the first wireless communication device 602 and the wireless communication device 604 can be operatively configured to perform the emitting, receiving, transmitting, etc., of wireless signals.

In a particular embodiment, extending between the first wireless communication device 602 and the second wireless communication device 604 is at least one cylinder ray 606. According to various aspects of the present disclosure, the at least one cylinder ray 606 is a data structure, such as a vector, that represents a point-to-point signal path between the first wireless communication device 602 and the second wireless communication device 604. In one embodiment, the cylinder ray 606 is evaluated within the discretized 3-D space generated via the process 500. Evaluating the cylinder ray 606 within the discretized 3-D space results in the corresponding data vector including any discretized point cloud data points intercepted along the point-to-point signal path. In particular embodiments, if a discretized point cloud data point is intercepted by the cylinder ray 606, the data vector corresponding to the cylinder ray 606 can include information associated with the intercepted discretized point cloud data points. In certain embodiments, the intercepted discretized point cloud data points represent classifications of obstacles or objects physically located in the cylinder ray's signal path.

In one embodiment, the cylinder ray 606 can include a radius based on the size(s) of the parsed 3-D units as discussed above in connection with the description of FIG. 5. For example, if an average, or most common, 3-D unit size from the process 500 is generally 1 cubic meter, the cylinder ray radius can be 0.1 m, 0.25 m, 0.5 m, 1 m, etc., or any appropriate size. In general, the cylinder ray radius is based on the 3-D unit size from the process 500 so that the cylinder ray is appropriately sized for intercepting obstacles as represented in the discretized point cloud data. For example, a cylinder ray that is larger in radius than the 3-D unit sizes will intercept every 3-D unit along its signal path, and a cylinder ray that is too small in radius may avoid intercepting any 3-D unit along its signal path.

In various embodiments, the system can be operatively configured to process nested cylinder rays, such that the system simulates multiple cylinder rays with varying radii along a common signal path. For example, and as shown in the environment 600, a nested cylinder ray 608 is shown extending along the same point-to-point signal path as the cylinder ray 606; however, the nested cylinder ray 608 includes a smaller radius as compared to the cylinder ray 606. In various embodiments, the nested cylinder ray 608, given its smaller radius, may intercept less obstacles along the point-to-point signal path. For example, and as shown in the present embodiment, the cylinder ray 606 may intercept obstacles such as trees 610 and 612, as well as rocky terrain 614, along the point-to-point signal path between the first wireless communication device 602 and the second wireless communication device 604. Accordingly, the trees 610 and 612, as well as the rocky terrain 614, would be indicated within the data vector corresponding to the cylinder ray 606. However, given the smaller radius of the nested cylinder ray 608, the cylinder ray 608 may not intercept any obstacles along the point-to-point signal path, and thus its corresponding data vector may be populated with discretized point cloud data points representative of open air. Moreover, the system can simulate more nested cylinder rays with varying radii, as appropriate, for evaluating the quantity and quality of obstacles along a particular signal path.

According to various aspects of the present disclosure, simulating the cylinder rays as illustrated in FIG. 6 allows for the system to optimize where wireless communication devices or network nodes are installed within a target location. For example, in response to evaluating a plurality of potential locations for installing a potential wireless communication device (such as a tower) by simulating one or more cylinder rays between each potential location and a plurality of hypothetical connected devices (mobile devices randomly distributed across an area of interest), the system can determine an optimal location for installing the wireless communication device. In one embodiment, the optimal location may be associated with a least amount of obstacles intercepted by cylinder rays. In various embodiments, evaluating a plurality of potential locations for installing a wireless communication device can include providing the cylinder rays as inputs to the machine learning or artificial intelligence model (such as the AI/ML module 107). For each potential location, the machine learning model can process the cylinder rays for the respective potential location, and the machine learning model can further compare the obstacles intercepted by the cylinder rays with relevant real-world signal data to determine an expected signal quality (such as signal strength and other aspects of wireless signals) for communications received at, and transmitted from, a wireless communication device installed at the potential location. In various embodiments, and in response to receiving cylinder rays as inputs, the machine learning model can leverage known deterministic and/or stochastic base relationships corresponding to signal characteristics and objects detected in the cylinder rays for determining an expected signal quality (and other signal characteristics/metrics). It should be understood from the discussion herein that simulating cylinder rays for determining signal qualities between two points can include analyzing signals bidirectionally between the points. For example, the system can be configured to process cylinder rays that are simulated to represent signals transmitted from a tower to a device, as well as cylinder rays that are simulated to represent signals transmitted from a device to a tower.

FIG. 7 is a flowchart of an example method and process 700 for tower-to-device or point-to-point signal quality analysis, according to one aspect of the present disclosure. As discussed above in connection with the description of FIG. 6, the system can simulate cylinder rays for evaluating and analyzing a signal quality (and other signal characteristics) between a wireless communication device to be installed at a potential location and the plurality of devices to which that wireless communication device may connect.

In one embodiment, the process 700 can begin at step 702, where the system receives real-world signal data in connection with obstacle data vectors including information corresponding to physical impediments located between wireless communication devices. In various embodiments, the real-world signal data can be licensed and/or unlicensed RF data, such as LTE, 5G New Radio (NR), etc., Wi-Fi® signal data (e.g., point-to-point or other Wi-Fi® data), cellular data, or other wireless signal data. Moreover, the system receives the real-world signal data in connection with obstacle data vectors. In a particular embodiment, the obstacle data vectors correspond to the cylinder rays discussed herein, which represent physical impediments located along a wireless signal path, and the corresponding signal quality along the signal path. For example, the obstacle data vectors (or simply “obstacle vectors”) can also include data such as angles off horizontal, angles off vertical, distances between the devices, parametrized antenna profiles, formulaic relationships such as free space loss, environmental parameters such as foliage characteristics, etc. In various embodiments, the obstacle vectors can furthermore include angles off antenna lobes, node/device placement parameters in 3-D space, foliage seasonality characteristics, and generally any other data that may be representative of a signal quality along the signal path.

At step 704, the system can train a machine learning model (such as the AI/ML module 107) based on the received and transmitted real-world signal data and corresponding obstacle data vectors. According to various aspects of the present disclosure, training the machine learning model in this way can result in the machine learning model codifying deterministic and/or stochastic base relationships characterizing known profiles and behaviors of wireless signals. Moreover, the machine learning model can codify deterministic and/or stochastic base relationships characterizing known profiles and behaviors of wireless signals in connection with the signal paths (cylinder rays) corresponding to the wireless signals.

In one embodiment, at step 706 the system can identify a target area for designing and installing a wireless network. According to various aspects of the present disclosure, the target area for designing and installing a wireless network can be any area in which a network may be built. In various embodiments, a target area can include a farm, rocky terrain, remote locations, etc.

In various embodiments, and generally in response to identifying a target area, the process 700 can execute the 3-D point cloud data discretization process 500 as described in connection with FIG. 5. According to various aspects of the present disclosure, the 3-D point cloud data discretization process 500 includes at least obtaining aerial point cloud data in connection with the target area and pre-processing the point cloud data to generate a discretized representation of the target area.

At step 708, in particular embodiments, the system can identify a potential location for a wireless communication tower (or a similarly appropriate wireless communication device) in an area of interest within the target area. In particular embodiments, identifying a potential location for a wireless communication tower can be a random process such that one or more potential locations are randomly selected and each potential location is evaluated independently. However, in various embodiments, a potential location can be identified based on characteristics associated with that particular potential location, such as relative elevation, physical proximity to obstructions (e.g., vegetation, structures, etc.). Locations that are relatively the highest in elevation and/or the furthest from obstructions may be preferred.

In at least one example, at step 710, the system can simulate a plurality of point-to-point connections corresponding to signal paths between the potential location for the wireless communication tower and a hypothetical plurality of devices distributed within the area of interest, where each simulated point-to-point connection includes an obstacle data vector representative of physical impediments detected along the respective signal path. In various embodiments, at step 710 the system can simulate the viability for the identified potential location as an actual location for installing a wireless communication tower. As will be understood by one of ordinary skill in the art, wireless network hardware should generally be installed in a physical location that allows for the most devices to connect to, and communicate with, the wireless network hardware. Accordingly, simulating a plurality of point-to-point connections corresponding to signal paths between the potential location for the wireless communication tower and a hypothetical plurality of devices distributed within the area of interest allows for the system to evaluate how a network design might perform if a wireless communication tower were installed at the potential location.

Proceeding now to step 712, the system can determine a simulation score or output (or any other appropriate metric, threshold, or measurement corresponding to the simulated signal quality, etc.) corresponding to the potential location for the wireless communication tower. In at least one embodiment, at step 712, the system can process the simulated point-to-point connections from step 710 to determine whether a wireless communication tower should be installed at the potential location. However, in various embodiments, the system is configured to determine an optimal location for installing a wireless communication tower in a target area, and thus the system can evaluate a plurality of potential locations. At step 712, the system can compare the simulation results for a potential location to prior simulations to determine whether the potential location resulted in an overall improvement in network design (for example, based on a decrease in physical impediments intercepted in the cylinder rays/signal paths).

At step 714, the system can determine whether an optimization limit has been identified. According to various aspects of the present disclosure, the system can continue to evaluate potential locations within an area of interest for installing a wireless communication tower until a predetermined threshold is met/satisfied, until a metric or value is achieved, until subsequent simulations fail to result in improved network characteristics, etc. For example, in one embodiment, the system can iterate (e.g., randomly, based on target area characteristics, based on ML determinations, etc.) through potential locations for installing a network communication tower, and for each potential location the system can process a simulated plurality of connected devices/nodes (via cylinder rays) for determining an average signal strength, or signal quality, across the plurality of connected devices/nodes. For each potential location, the system can also process a simulated plurality of connected devices/nodes (via cylinder rays) for determining the statistical characteristics of a signal strength, or signal quality, across the plurality of connected devices/nodes (for example, based on the cylinder ray contents). In one embodiment, the system can continue to evaluate subsequent potential locations until the average signal strength, or signal quality, plateaus or fails to meaningfully increase with additional simulations (optimization run output convergence). In particular embodiments, the system can continue to evaluate subsequent potential locations until the statistical characteristics of signal strength, or signal quality, plateaus or fails to meaningfully increase with additional simulations (optimization run output convergence). Therefore, if at step 714 the system determines that the optimization limit has not been identified, the process 700 can return to step 708 to identify a subsequent potential location for evaluation. However, if at step 714 the system determines that the optimization limit has been identified, the process 700 can end. It should be understood from the discussion herein that notwithstanding the process 700 ending in response to an optimization limit being identified, the system can perform a similar process in connection with a different area of interest for installing one or more wireless communication devices.

### CONCLUSION

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can include various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions include, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed inventions may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represents examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor r systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program engines may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program engines, and other data for the computer.

Computer program code that implements the functionality described herein typically includes one or more program engines that may be stored on a data storage device. This program code, as is known to those skilled in the art, usually includes an operating system, one or more application programs, other program engines, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LAN (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program engines depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed technology will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the technology to the precise forms disclosed. Many modifications and variations are possible in light of the above teaching.

The embodiments were chosen and described in order to explain the principles of the technology and their practical application so as to enable others skilled in the art to utilize the technology and various embodiments and with various modifications as are suited to the particular use contemplated. Alternative embodiments will become apparent to those skilled in the art to which the technology pertains without departing from their spirit and scope. Accordingly, the scope of the present technology will ultimately be defined by the claims in any resulting issued patent rather than the foregoing description and the exemplary embodiments described therein.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

What is claimed is:

1. A system, comprising:
a processor; and
a memory on which are stored machine-readable instructions that when executed by the processor, cause the processor to:
acquire aerial surveillance data of a target area, wherein the aerial surveillance data comprises a point cloud dataset;
initiate parsing of the point cloud dataset in intervals defined by a plurality of three-dimensional (3-D) units of a predetermined volume, wherein parsing comprises analyzing a plurality of point cloud data points located within each 3-D unit of the plurality of 3-D units of the predetermined volume; and
in response to determining that a threshold amount of point cloud data points of a plurality of point cloud data points located within a particular 3-D unit are of a common surface classification type, replace the plurality of point cloud data points within the particular 3-D unit with a single data point indicative of the common surface classification type.

2. The system of claim 1, wherein in response to executing the machine-readable instructions the processor is further caused to:
in response to determining that a threshold amount of point cloud data points of a plurality of point cloud data points located within a subsequent 3-D unit are not of a common surface classification type, replace the subsequent 3-D unit with a subdivided 3-D unit comprising a plurality of tessellated 3-D units;
initiate parsing of the point cloud dataset in intervals defined by the plurality of tessellated 3-D units; and
in response to determining that a threshold amount of point cloud data points of a plurality of point cloud data points located within a particular tessellated 3-D unit of the plurality of tessellated 3-D units is of a common surface classification type, replace the point cloud data points within the particular tessellated 3-D unit with a single data point indicative of the common surface classification type.

3. The system of claim 2, wherein each tessellated 3-D unit comprises a volume that is less than the predetermined volume.

4. The system of claim 1, wherein in response to executing the machine-readable instructions the processor is further caused to:
in response to replacing the plurality of point cloud data points located within each 3-D unit of the plurality of 3-D units with a single data point indicative of the common surface classification type, generate a discretized 3-D mapping of the point cloud dataset comprising each of the single data points indictive of their respective common surface classification type.

5. The system of claim 4, wherein in response to executing the machine-readable instructions the processor is further caused to:
acquire wireless signal quality data corresponding to wireless signals detected within the target area in connection with the aerial surveillance data; and
provide the wireless signal quality data and the discretized 3-D mapping to a machine learning (ML) module, wherein the ML module is operatively configured to codify base relationships characterizing known profiles and behaviors of the wireless signals and other electronic elements to be used in a wireless network design for the target area.

6. The system of claim 1, wherein the aerial surveillance data comprises photogrammetry data, LiDAR data, and/or thermal imagery data.

7. The system of claim 6, wherein the wireless signal quality data comprises 3-D sequential signal quality data collected by a signal detection device passing through a plurality of vertical planes located at a standard distance from each other over the target area.

8. A method, comprising:
acquiring aerial surveillance data of a target area, wherein the aerial surveillance data comprises a point cloud dataset;
initiating parsing of the point cloud dataset in intervals defined by a plurality of three-dimensional (3-D) units of a predetermined volume, wherein parsing comprises analyzing a plurality of point cloud data points located within each 3-D unit of the plurality of 3-D units of the predetermined volume; and
in response to determining that a threshold amount of point cloud data points of a plurality of point cloud data points located within a particular 3-D unit are of a common surface classification type, replacing the plurality of point cloud data points within the particular 3-D unit with a single data point indicative of the common surface classification type.

9. The method of claim 8, further comprising:
in response to determining that a threshold amount of point cloud data points of a plurality of point cloud data points located within a subsequent 3-D unit are not of a common surface classification type, replacing the subsequent 3-D unit with a subdivided 3-D unit comprising a plurality of tessellated 3-D units;
initiating parsing of the point cloud dataset in intervals defined by the plurality of tessellated 3-D units; and
in response to determining that a threshold amount of point cloud data points of a plurality of point cloud data points located within a particular tessellated 3-D unit of the plurality of tessellated 3-D units is of a common surface classification type, replacing the point cloud data points within the particular tessellated 3-D unit with a single data point indicative of the common surface classification type.

10. The method of claim 9, wherein each tessellated 3-D unit comprises a volume that is less than the predetermined volume.

11. The method of claim 8, further comprising:
in response to replacing the plurality of point cloud data points located within each 3-D unit of the plurality of 3-D units with a single data point indicative of the common surface classification type, generating a discretized 3-D mapping of the point cloud dataset comprising each of the single data points indictive of their respective common surface classification type.

12. The method of claim 11, further comprising:
acquiring wireless signal quality data corresponding to wireless signals detected within the target area in connection with the aerial surveillance data; and
providing the wireless signal quality data and the discretized 3-D mapping to a machine learning (ML) module, wherein the ML module is operatively configured to codify base relationships characterizing known profiles and behaviors of the wireless signals and other electronic elements to be used in a wireless network design for the target area.

13. The method of claim 8, wherein the aerial surveillance data comprises photogrammetry data, LiDAR data, and/or thermal imagery data.

14. The method of claim 13, wherein the wireless signal quality data comprises 3-D sequential signal quality data collected by the UAS passing through a plurality of vertical planes located at a standard distance from each other over the target area.

15. A non-transitory computer readable medium comprising instructions, that when read by a processor, cause the processor to perform:
acquiring aerial surveillance data of a target area, wherein the aerial surveillance data comprises a point cloud dataset;
initiating parsing of the point cloud dataset in intervals defined by a plurality of three-dimensional (3-D) units of a predetermined volume, wherein parsing comprises analyzing a plurality of point cloud data points located within each 3-D unit of the plurality of 3-D units of the predetermined volume; and
in response to determining that a threshold amount of point cloud data points of a plurality of point cloud data points located within a particular 3-D unit are of a common surface classification type, replacing the plurality of point cloud data points within the particular 3-D unit with a single data point indicative of the common surface classification type.

16. The non-transitory computer readable medium of claim 15, further comprising instructions that when read by the processor, cause the processor to perform:
in response to determining that a threshold amount of point cloud data points of a plurality of point cloud data points located within a subsequent 3-D unit are not of a common surface classification type, replacing the subsequent 3-D unit with a subdivided 3-D unit comprising a plurality of tessellated 3-D units;
initiating parsing of the point cloud dataset in intervals defined by the plurality of tessellated 3-D units; and
in response to determining that a threshold amount of point cloud data points of a plurality of point cloud data points located within a particular tessellated 3-D unit of the plurality of tessellated 3-D units is of a common surface classification type, replacing the point cloud data points within the particular tessellated 3-D unit with a single data point indicative of the common surface classification type.

17. The non-transitory computer readable medium of claim 16, wherein each tessellated 3-D unit comprises a volume that is less than the predetermined volume.

18. The non-transitory computer readable medium of claim 15, further comprising instructions that when read by the processor, cause the processor to perform:
in response to replacing the plurality of point cloud data points located within each 3-D unit of the plurality of 3-D units with a single data point indicative of the common surface classification type, generating a discretized 3-D mapping of the point cloud dataset comprising each of the single data points indictive of their respective common surface classification type.

19. The non-transitory computer readable medium of claim 18, further comprising instructions that when read by the processor, cause the processor to perform:
acquiring wireless signal quality data corresponding to wireless signals detected within the target area in connection with the aerial surveillance data; and
providing the wireless signal quality data and the discretized 3-D mapping to a machine learning (ML) module, wherein the ML module is operatively configured to codify base relationships characterizing known profiles and behaviors of the wireless signals and other electronic elements to be used in a wireless network design for the target area.

20. The non-transitory computer readable medium of claim 15, wherein the aerial surveillance data comprises photogrammetry data, LiDAR data, and/or thermal imagery data, and wherein the wireless signal quality data comprises 3-D sequential signal quality data collected by a signal detection device passing through a plurality of vertical flight planes located at a standard distance from each other over the target area.
